(19) United States
(12) Patent Application Publication
(10) Pub. No.: US 2022/0212861 A1
(43) Pub. Date: Jul. 7, 2022

(54) COVERING FOIL, ESPECIALLY FOR FOOD CAPSULES

(71) Applicant: Constantia Pirk GmbH & Co. KG, Pirk (DE)

(72) Inventors: Markus Kick, Weiden/Opf. (DE); Thomas Kesmarszky, Weiherhammer (DE); Robert Kitzberger, Stollhofen (AT); Paolo Battiston, Sankt Pölten (AT); Denise Wagner, Kirchberg an der Pielach (AT)

(21) Appl. No.: 17/608,621

(22) PCT Filed: May 8, 2020
(86) PCT No.: PCT/EP2020/062879

§ 371 Date: Nov. 3, 2021

(30) Foreign Application Priority Data
May 8, 2019 (DE) 10 2019 112 034.9

(51) Int. Cl. B65D 85/804; B65D 65/42; C09D 123/12; C09D 123/14; C08F 10/06

(52) U.S. Cl. CPC B65D 85/8043; B65D 65/42; C08F 10/06; C09D 123/142; C09D 123/12

(57) ABSTRACT

Capsule for taking up, in particular, powder or granular substances, having a base body (22) which is suitable for taking up a powder or granular substance and which has an opening (26), and having a cover for closing the opening (26) of the base body (22), the cover being a covering foil having an aluminium-containing carrier and a coating (4) arranged on this carrier (2), the coating being an atactic coating containing polypropylene. Furthermore, the invention relates to a foil (1), in particular a covering foil for closing an opening of a base body (22) suitable for taking up a powder or granular substance, forming a capsule, the foil comprising an aluminium-containing carrier and an atactic, polypropylene-containing coating arranged on this carrier (2), as well as a method for manufacture of such a foil (1), a carrier made of an aluminium-containing material being provided and an atactic, polypropylene-containing coating (4) being arranged on this carrier.

The present invention relates to a capsule for taking up, in particular, powder or granular substances, comprising a base body which is suitable to take up a powder or granular substance and which has an opening, and a cover for closing the opening of the base body, the cover being a cover foil having a carrier containing aluminium and a coating arranged on this carrier. Furthermore, the invention relates to such a cover foil suitable for closing such a capsule.

For some time now, capsules have been known from the prior art which are used, for example, to contain coffee or tea powder. These capsules usually have a cover film which is intended to close off the interior of the capsule.

Such capsules are usually made of a plastic such as PP (polypropylene). Cover foils for such capsules are known from the prior art. These usually have laminates, such as PET, aluminum or BOPP (a film of biaxially oriented polypropylene). Laminates of PET/PET and CPP are also known to seal these capsules. Such laminates are multilayer structures, but are not very environmentally friendly, difficult to recycle, very material consuming and cost intensive. In addition, such layers are sometimes difficult to cut or die-cut and have a certain tendency to curl, which creates great difficulties when sealing die-cut cover foils onto the opening of capsules.

In addition, combinations of aluminium foils coated with heat-sealing substances or heat-sealing lacquers for sealing against PP substrates are also known from the applicant's internal prior art. These foils do not have the necessary very high sealing seam strength and also the hot-tack properties of the coating (which are particularly important for applications in non-degassed coffee) are too weak.

This means that the capsule opens very quickly or the cover foil detaches from the capsule as soon as the sealing seam is exposed to temperatures of over 60° C. This is particularly the case when the coffee is prepared at temperatures of up to 100° C. and internal pressure in the capsule of up to 12 bar. Pure formulations with conventional heat-sealing lacquer made of polyolefin copolymers also exhibit problems with regard to spontaneous ignition at high drying temperatures, especially when solvents with too low a spontaneous ignition temperature are used.

The present invention is therefore based on the task of providing a capsule for taking up, in particular, powdered or granular substances, having a base body which is closed with a foil and, in particular, a coated foil, which has sufficient sealing seam strength, in particular in the hot state, and internal pressure strength, but, on the other hand, also does not involve the above-mentioned disadvantages.

These tasks are achieved according to the invention by the subject matter of the independent claims. Advantageous embodiments and further embodiments are the subject matter of the subclaims.

A capsule according to the invention for taking up substances, in particular in powder or granular form, comprises a base body which is suitable for taking up a coffee and which has an opening. This opening is provided with a cover for closing the opening of the base body, the cover being a cover foil comprising a carrier containing aluminium and comprising a coating arranged on this carrier. According to the invention, said coating is an atactic polypropylene containing coating.

Particularly preferably, the coating comprises at least one other component in addition to polypropylene. Particularly preferably, the coating is selected from a group of coatings comprising polypropylene, polypropylene/polyethylene and polypropylene/α-olefin copolymer.

Such coatings have been shown to be advantageous in that they are easy to process, have sufficient seal strength even at low application amount, and retain seal integrity even at high temperatures, such as when hot water or steam is passed through the capsule. Furthermore, it has been shown that this polypropylene copolymer coating does not release any detectable substances into the fluid stream even when hot water or steam is passed through the capsule and thus—for example with coffee or tea—does not distort the desired taste.

In a preferred embodiment, a first surface of the foil and a second surface opposite this first surface have different roughnesses. Particularly preferably, one of the surfaces of the foil is structured. This structure preferably exhibits, at least in sections, a disordered (chaotic) shape. In particular, this is the surface which, in a state of the cover foil arranged on a capsule, constitutes the outer surface.

This allows that after local puncture of the foil and subsequent passing of hot water or steam through the capsule, this medium can interact with the solid material contained in the capsule and the product thus produced can flow along the side of the foil facing away from the interior of the capsule via a large number of different channels formed by the disordered surface s structure. This allows gas, for example air, to enter structures not currently filled by the product, but from where it can be entrained when the flow pattern changes. In this way, a voluminous and stable crema can be achieved, especially with coffee.

In a further advantageous embodiment, the carrier is provided with the polypropylene copolymer coating on one side. As a result, an extremely small application amount can be realized. The opposite side of the carrier may be coated with printing inks and overprint varnishes.

In a preferred embodiment, the coating is applied over the entire surface of the substrate. This simplifies the application procedure in comparison with merely local application. Since the polypropylene copolymer coating as described above and typical conditions of use is at least largely inert to the media contacting this, no detectable transfer of the polymer into the product occurs in this embodiment either. Preferably, the coating is applied to the carrier with a constant thickness or grammage. Preferably, this is less than 5 g/m² dry weight. In a further preferred embodiment, the thickness of the coating is less than the thickness of the carrier.

In a further advantageous embodiment, the carrier is an aluminium foil and in particular a mono aluminium foil. This allows for a sufficiently high stability at a low thickness and material cost without causing curling of the cover foil or poor planarity of the cover foil. In addition, puncture of the foil to open the capsule is simplified and little stress is placed on the puncture tool, even with repeated use. Moreover, this embodiment can be die-cutted very well.

Preferably, the coating is abrasion resistant. In addition to the machinability of the foil on the filling machine, this is particularly advantageous because it can be ensured in this way that, even during transport of a filled capsule closed with such a foil, the product contained is not contaminated by abrasion with the coating or its ingredients, even if it slides along the coating several times. Preferably, the foil surface does not contain lubricants. If the foil surface does not contain any lubricants (which are known to be used as standard in sealing foils), there is no migration of such substances into the filling product even during prolonged storage.

In another preferred embodiment, the coating is an atactic polypropylene copolymer coating. As is well known, tacticity describes the arrangement of side chains in a polymer recurring at certain intervals. In the case of polypropylene, tacticity can occur. In the case of atactic polypropylene, the arrangement of residues is random. In general, most types of polypropylene are isotactic. Preferably, however, atactic polypropylene (PP-R) is used in the context of the invention.

In another preferred embodiment, the coating is a random copolymer. In an alternative embodiment, the coating is one or more block copolymer(s).

Alternating copolymers are also conceivable, although less preferred. By controlling the sequence of the (at least two and in particular preferably exactly two) different monomers in the polymer, the property of the copolymer can be adjusted according to the requirements.

Preferably, the polypropylene copolymer coating has a monomer sequence that provides sufficiently strong adhesion and cohesive strength in the particular temperature range intended for use while maintaining sufficient temperature and abrasion resistance.

In particular, it is preferred that the copolymer is selected in such a way that in the temperature range between 10-110° C., in particular preferably 20-100° C., sufficiently strong adhesive strength and cohesion are ensured, while at the same time sufficient temperature and abrasion resistance as well as internal compressive strength are ensured.

In a further preferred embodiment, the carrier has a thickness which is greater than 5 μm, preferably greater than 10 μm, more preferably greater than 15 μm. In a further preferred embodiment, the carrier has a thickness which is less than 100 μm, preferably less than 80 μm, preferably less than 60 μm and particularly preferably less than 50 μm. These aforementioned thicknesses have proven to be particularly suitable for satisfying the above-mentioned requirements with respect to resistance.

At the same time, the puncture of the foil to open the capsule can be guaranteed with these material thicknesses and the correspondingly designed puncture tool can also be designed for multiple use, depending on the application.

Preferably, the coating is also resistant to blocking in the roll winding. This can be adjusted, for example, by the selection of the sequence of the different monomers in the copolymer described above and/or the tacticity of the polymer.

Preferably, the foil exhibits sufficient heat seal strength or internal compressive strength at temperatures greater than 40° Celsius, preferably greater than 50° Celsius, and more preferably greater than 60° Celsius. This can ensure that the foil will not deform or otherwise be damaged even when exposed (at least briefly) to such a temperature. The inclusion of a printing and/or the retention or creation of a defined surface structure under temperature impact or by embossing can also be ensured in this way.

In a further preferred embodiment, the foil (or the bond between the foil and the base body) has a sealing seam strength of more than 5 N per 15 mm, preferably more than 10 N per 15 mm, particularly preferably more than 20 N per 15 mm, sealed against PP and at a sealing temperature of more than 160° Celsius, preferably more than 170° Celsius, in particular preferably more than 180° Celsius. The required sealing time for this is at least 0.3 sec, with a sealing pressure of at least 2.3 bar. This sealing time ensures that a sufficiently strong pressure resistance of the capsule can be achieved. In particular, it is ensured that the capsule withstands this pressure when preparing a coffee at temperatures of up to 100° C. and a simultaneous internal pressure in the capsule of up to 12 bar. Preferably, the capsule has an internal pressure resistance of at least 12 bar.

The advantage of this embodiment is that the foil is suitable for both degassed and non-degassed coffee.

In a further preferred embodiment, the coating is applied with an application weight which is greater than 0.5 g/m², preferably greater than 0.7 g/m², and more preferably greater than 1.0 g/m². These indications refer in particular to the dry coating weight. These advantageous coating application weights can ensure a sufficient sealing force of the foil and a sufficient permanent sealing force of the sealant.

In another preferred embodiment, the coating is an atactic propylene-containing coating and in particular an atactic polypropylene and/or polypropylene/polyethylene and/or polypropylene/α-olefin copolymer coating dispersed and applied by means of a mixture of isoparaffins.

In another preferred embodiment, the carrier is a tempered foil and in particular a soft annealed foil.

In a further preferred embodiment, the coating is applied with an application weight which is less than 5 g/m², preferably less than 4 g/m², preferably less than 3 g/m², preferably less than 2 g/m² and particularly preferably less than 1.5 g/m². In particular, these data refer to the dry coating weight. At these application weights, a sufficiently efficient sealing is ensured and the material requirement is reduced.

In a further preferred embodiment, the coating comprises a polypropylene copolymer blend and, in particular, an atactic polypropylene copolymer blend dissolved and/or dissolved or emulsified in a solvent (mixture). The viscosity of the mixture is thereby adjusted by adjusting the solids content so as to enable the skilled person to process it on a conventional coating machine to obtain the desired application amounts.

Preferably, this solvent is a substantially non-polar solvent. Particularly preferred are solvents with a high hydrocarbon content, in particular a high content of hydrocarbons with 6-20, preferably 8-15, particularly preferably 10-12 carbon atoms.

Preferably, the coating comprises a random and/or homo polypropylene this preferably forms the base or main component of the polypropylene or polypropylene copolymer blend. Preferably, this is used as dispersions. Exemplary properties of such a dispersion are shown in the following table:

TABLE 1
Exemplary properties of suitable PP dispersions

| Variety | 1 | 2 | 3 |
|---|---|---|---|
| Mean particle size (sedigraph) | 10 | 10 | 10 |
| [μm]. | | | |
| Viscosity Type B [mPas] | 10 | 40 | 50 |
| Viscosity tooth cup [s] | 8 | 9 | 12 |
| Non-volatile components [%] | 20 | 25 | 18 |
| Base polymer | homo-PP | homo-PP | random-PP |
| Melting point [° C.] | 156/162 | 150/156 | 136/144 |

The temperature data in this table are only exemplary and should be known to a person skilled in the art. The melting temperature could be used to differentiate between various suitable dispersions.

Preferably, the average particle size (sedigraph) is thus about 10 μm, preferably in the range of 10±6 μm. The viscosity can be selected in a comparatively wide range of preferably 5-100 mPas (type B) or 5-20 s (tooth cup). The proportion of non-volatile components is preferably in the range of 15-35%. In addition to the above examples and those shown in the table, mixtures between random and homo PP are also possible.

Regardless of this, a high proportion of aliphatic hydrocarbons is preferred. In particular, it is preferred that the proportion of cyclic hydrocarbons is less than 20%, preferably less than 10%, more preferably less than 5%. Regardless of this, it is further preferred that the proportion of aromatic hydrocarbons is low, preferably below 10%, more preferably below 5%, most preferably below 2% and more particularly preferably below 0.01%.

All of the above percentages, as in the remainder of the description of the present invention—unless explicitly stated otherwise—refer in each case to percent by mass. A particularly suitable solvent has been found to be light petroleum fraction such as naphtha or crude gasoline. Isopar G (ExxonMobil Chemical) has proven to be particularly suitable as a solvent. This evaporates sufficiently quickly and is at least mostly residue-free. The choice of the melting temperature of the polypropylene copolymer, which is preferably in a temperature range of about 100-165° C., ensures that there is no thermal damage to the coating during the drying process and during the film formation of the polypropylene coating.

The polypropylene preferably has an average molecular weight (Mw) in the range of 30,000-200,000 g/mol, further preferably 40,000-180,000 g/mol, more preferably 50,000-150,000 g/mol.

In another preferred embodiment, the coating and the solvent (mixture) used have a self-ignition temperature greater than 200°, preferably greater than 220°, preferably greater than 240°, more preferably greater than 260°, and particularly preferably greater than 300° C. This is advantageous so that the coating can be safely dried convectively in a drying tunnel with heated air.

Particularly preferably, the melting point of the high molecular weight polypropylene copolymers is greater than 100° Celsius, preferably greater than 120° Celsius and preferably greater than 140° Celsius. In this way, a high heat seal strength (hot tack, warm seam strength) can be achieved. Also, in this way, a high sealing strength and/or performance can be achieved so that no delamination or leakage of the sealing seam occurs during the brewing process in the coffee preparation machine.

In order to adjust the adhesive force or adhesion on the aluminium surface, the polypropylene copolymer can also be present, for example, as a polypropylene/polyethylene copolymer and polypropylene-α-olefin copolymer, which has been end-grafted with maleic anhydride, for example. The contents of maleic anhydride portion of the total polymer are typically in a range of 0.1-2%.

This coating foil can, for example, be applied to a PP capsule and, in particular, be applied in a seal-tight manner. For this purpose, it is particularly preferred to work with a temperature range which is between 160° and 250° Celsius, preferably between 170° and 240° Celsius. The application of the foil can be carried out over a period of time of, for example, between 0.2 seconds and 1.0 seconds, preferably between 0.4 seconds and 0.6 seconds. The pressure used to apply the foil is preferably greater than 2.3 bar. Compared to many other coating foils, even higher process speeds can thus be achieved.

In a further preferred embodiment, the foil has circumferential edges which are curved at least in sections, and more preferably at least in sections and more preferably approximately and preferably completely circularly curved edges. It is particularly preferred that the foil has a smaller or identical outer diameter than a container opening to be covered by it. In this way, it can be ensured that the foil cannot be unintentionally removed, for example peeled off, from the container.

Preferably, the capsule contains polypropylene as the main component and particularly preferably exhibits barrier properties.

In particular, it is provided that the base body has an opening which is preferably fully covered by a foil as described above and thus in particular preferably closed. This enables, on the one hand, aroma sealing of the powder or granules within the receptacle in the base body and, on the other hand, rapid and simple opening of the container thus formed with release of the powder or granules.

Preferably, the substance (preferably in powder form) is coffee or tea. These substances can be stored in a medium- or even long-term aroma-preserving manner by means of a capsule as described above.

In another preferred embodiment, the base body is made of a plastic and in particular PP (polypropylene) with an optionally embedded barrier layer of ethylene vinyl alcohol (EVOH) copolymer. Since polypropylene has been shown to be particularly impermeable to both the powder or granules and the flavouring agents contained in tea or coffee, PP is particularly preferred. A variety of possible constructions for capsule walls are described in the technical literature or are known to the skilled person from the prior art.

The present invention is further directed to a foil having a carrier comprising aluminium and a coating disposed on said carrier. The coating is an atactic coating comprising polypropylene and is connectable to a base body of a capsule as described above. The capsule is particularly suitable for containing powdered or granular substances, for example a powdered coffee or tea. In this case, the foil forms a cover for covering and/or sealing and/or closing the base body.

Preferably, the coated foil is sealable against the capsule.

In other respects, it is preferred that the foil has properties as described above for the foil in combination with the base body of a capsule forming a capsule.

The present invention is further directed to a method for manufacture of a foil and, more particularly, a cover foil for covering capsules, wherein a carrier of an aluminium-containing material is provided and a coating is disposed on said carrier.

According to the invention, the coating is an atactic polypropylene-containing coating and, in particular, an atactic polypropylene and/or polypropylene/polyethylene and/or polypropylene/α-olefin copolymer coating.

In a further embodiment, and in particular for special applications, amorphous polypropylene-polyethylene copolymers or blends of polypropylene/polypropylene-polyethylene copolymers are used for the coating, since they differ from their homopolymers in properties.

Instead of one monomer, two or three comonomers are preferably polymerized together, which are particularly preferably randomly incorporated into the polymer chain.

Thus, depending on the mixing ratio of the comonomers, adapted properties can be generated and the solubility can be achieved not only in aromatics but also in higher ketones. The solubility of polypropylene/polyethylene copolymers increases when the proportion of polypropylene is between 40 and 80 wt. %.

While stereospecific catalysts are usually used for olefinic homopolymers, non-specific catalysts are used for statistical polypropylene/polyethylene copolymers in which ethylene is usually involved as a component. In this case, amorphous or semi-crystalline chemically and physically uniform copolymers are obtained particularly easily.

While the occurrence of crystallization in PP/PE copolymers is considered to be a characteristic of a tactical structure, isotactic or syndiotactic, PP/PE copolymers, being soluble or present as a dispersion, are considered to be atactic. This assumption is often correct, but is only partially true for PP/PE copolymers.

The PP/PE copolymer coating according to the invention exhibits very good flowability, internal strength, viscoelasticity, paintability and resistance to heat and sterilization for use and application.

In a preferred embodiment, the coating is applied on a coating machine known per se from the prior art, which applies the coating in liquid form using a smooth roller applicator. This application can be carried out, for example, with a wet film grammage of 5 to 10 g/m² onto the foil surface, for example in a roll-to-roll process.

Preferably—in particular subsequently—the wet paint film is dried in the coating machine—preferably convectively—via hot air supply in the drying tunnel (tunnel oven) and preferably over several drying zones by setting a temperature profile that is not critical for occupational safety (removal of the solvent content in the paint).

It is further preferred that the atactic polypropylene and/or atactic polypropylene/polyethylene and/or atactic polypropylene/α-olefin copolymer coating is applied—in particular over the entire surface—to the foil surface and in particular is melted (the coating film is formed by coalescence).

After film formation, the foil is preferably wound onto a roll and is available for further processing. Several application units and drying tunnels can also be arranged in series in order to apply several coats or layers of coating.

Preferably, drying of the coating takes place at a temperature which is greater than 100°, preferably greater than 150°, preferably greater than 200°, preferably greater than 220° Celsius. Particularly preferably, drying of the coating takes place at a temperature which is less than 300° Celsius, preferably less than 280° Celsius, preferably less than 260° Celsius and particularly preferably less than 240° Celsius.

In another preferred embodiment, a mixture of polypropylene copolymer and, in particular, atactic polypropylene copolymer dissolved in a solution mixture and/or used in the form of a solution is used to produce the coating.

In a further preferred embodiment, after the coating has been applied and in particular also after the coating has dried, pieces of foil are cut out or punched out of the coated foil.

Further advantages and embodiments will be apparent from the accompanying drawings.

Show in it:

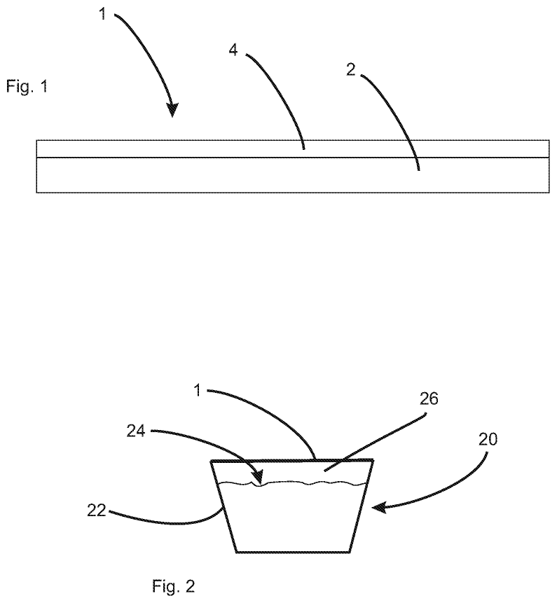

FIG. 1a schematic representation of a cover foil according to the invention; and

FIG. 2 an illustration of the cover foil arranged on a capsule.

FIG. 1 shows a schematic representation of a cover foil according to the invention. This cover foil has a carrier 2, as well as a coating 4 arranged on this carrier 2, this coating 4 being produced from a polypropylene copolymer and, in particular, from an atactic polypropylene copolymer.

FIG. 2 shows a schematic representation of a capsule 20 according to the invention for taking up a powder or granular substance 24. This capsule has a base body 22 on which the cover foil 1 is arranged. Preferably, the outwardly facing surface of the cover foil 1 is structured. The reference sign 26 indicates an opening of the capsule which is covered by the cover foil 1. The foil can thereby adhere completely to the edge of the base body.

The applicant reserves the right to claim all features disclosed in the application documents as essential to the invention, provided that they are individually or in combination new compared to the prior art. It is further pointed out that the individual figures also describe features which may be advantageous in themselves. The skilled person immediately recognizes that a particular feature described in a figure can be advantageous even without adopting further features from that figure. Furthermore, the skilled person recognizes that advantages can also result from a combination of several features shown in individual figures or in different figures.

### LIST OF REFERENCE SIGNS

1 Cover foil
2 Carrier
4 Coating
20 Capsule
22 Basic body
24 Substance
26 Opening of the capsule

1. Capsule for taking up substances, in particular in powder or granular form, comprising a base body (22) which is suitable for taking up a powder or granular substance and which has an opening (26), and providing a cover for closing the opening (26) of the base body (22), the cover being a cover foil comprising a carrier (2) containing aluminium and a coating (4) arranged on this carrier (2),
characterized in that
the coating is an atactic coating which contains polypropylene.

2. Capsule according to claim 1,
characterized in that
the coating of the cover foil is a polypropylene or polypropylene/polyethylene or polypropylene/α-olefin copolymer coating (4).

3. Capsule according to claim 1,
characterized in that
the carrier (2) of the cover foil is an aluminium foil (2).

4. Capsule according to at least one of the preceding claims,
characterized in that
the carrier (2) of the covering foil has a thickness which is greater than 5 μm, preferably greater than 10 μm, preferably greater than 15 μm and/or the carrier (2) has a thickness which is less than 100 μm, preferably less than 80 μm, preferably less than 60 μm.

5. Capsule according to at least one of the preceding claims,
characterized in that
the bond between the foil and the base body has a sealing seam strength of more than 5 N per 15 mm, preferably of more than 10 N per 15 mm, particularly preferably of more than 20 N per 15 mm, and/or the capsule has an internal pressure resistance of at least 12 bar.

6. Capsule according to at least one of the preceding claims,
characterized in that
the coating (4) of the cover foil is applied with an application weight which is greater than 0.5 g/m² preferably greater than 0.7 g/m² and preferably greater than 1.0 g/m² and/or that the coating (4) is applied with an application weight which is less than 5 g/m² preferably less than 4.0 g/m², preferably less than 3.0 g/m², preferably less than 2.0 g/m² and preferably less than 1.5 g/m².

7. Capsule according to at least one of the preceding claims,
characterized in that
the coating of the cover foil comprises an atactic polypropylene and/or polypropylene/polyethylene and/or polypropylene/α-olefin copolymer coating dispersed and applied by means of a mixture of isoparaffins.

8. Capsule (20) according to at least one of the preceding claims,
characterized in that
the base body is made of a plastic and in particular of PP or of PP and an embedded barrier plastic, preferably ethylene-vinyl alcohol (EVOH) copolymer.

9. Capsule according to any one of the preceding claims,
characterized in that
the coated foil is sealed against a base body of the capsule, said base body preferably comprising polypropylene as a main component and particularly preferably having barrier properties.

10. Foil (1), in particular a cover foil for closing an opening of a base body (22) suitable for taking up a powder or granular substance, forming a capsule according to one of the preceding claims, wherein the foil comprises a carrier (2) containing aluminium and a coating (4) arranged on this carrier (2),
characterised in that
the coating is an atactic coating containing polypropylene.

11. Film (1) according to claim 10,
characterized in that
the coating is a polypropylene and/or polypropylene/polyethylene and/or polypropylene/α-olefin copolymer coating (4).

12. Film (1) according to at least one of the preceding claims,
characterized in that
the carrier (2) has a thickness which is greater than 5 μm, preferably greater than 10 μm, preferably greater than 15 μm and/or the carrier (2) has a thickness which is less than 100 μm, preferably less than 80 μm, preferably less than 60 μm.

13. Film (1) according to at least one of the preceding claims,
characterized in that
the coating (4) is applied with an application weight which is greater than 0.5 g/m² preferably greater than 0.7 g/m² and preferably greater than 1.0 g/m² and/or that the coating (4) is applied with an application weight which is less than 5 g/m² preferably less than 4.0 g/m², preferably less than 3.0 g/m², preferably less than 2.0 g/m² and preferably less than 1.5 g/m².

14. Film (1) according to at least one of the preceding claims,
characterized in that
the coating (4) comprises an atactic propylene-containing coating and, in particular, an atactic polypropylene and/or polypropylene/polyethylene and/or polypropylene/α-olefin copolymer coating dispersed and applied by means of a mixture of isoparaffins.

15. Method for manufacture of a foil (1) and in particular a cover foil for covering capsules, wherein a carrier of an aluminium-containing material is provided and a coating is arranged on this carrier,
characterised in that
the coating is an atactic polypropylene-containing coating and in particular a polypropylene and/or polypropylene/polyethylene and/or polypropylene/α-olefin copolymer coating.
